(19) United States
(12) Patent Application Publication
(10) Pub. No.: US 2018/0154347 A1
(43) Pub. Date: Jun. 7, 2018

(54) Method of Acid Manufacturing Using Ion Exchange Resins

(71) Applicant: Gerald J. Grott, Phoenix, AZ (US)

(72) Inventor: Gerald J. Grott, Phoenix, AZ (US)

(21) Appl. No.: 15/834,034

(22) Filed: Dec. 6, 2017

Related U.S. Application Data
(60) Provisional application No. 62/430,507, filed on Dec. 6, 2016.

(51) Int. Cl. B01J 39/17; B01J 39/14; B01J 39/07; B01J 49/53

(52) U.S. Cl. CPC B01J 39/17; B01J 49/53; B01J 39/07; B01J 39/14

(57) ABSTRACT

A method of acid manufacturing using ion exchange resin allows for the production of acids on location where the acid is being utilized to prevent the necessity of transporting the acid. An ion exchange medium provides a medium for substituting hydrogen ions for salt cations within a salt solution in order to protonate the salt solution. As the salt solution becomes protonated to form an acid solution from the respective salt anion as the concentration of hydrogen increases. The ion exchange medium is recharged with a hydrogen ion source solution. The ion exchange resin is safe to transport even while charged with hydrogen ions.

The current application claims a priority to the U.S. Provisional Patent application Ser. No. 62/430,507 filed on Dec. 6, 2016.

### FIELD OF THE INVENTION

The present invention relates generally to acid production. More specifically, the present invention relates to the production of acids using ionic exchange media, such as a resin, a natural zeolite, or a manufactured zeolite.

### BACKGROUND OF THE INVENTION

Ion exchange is a process in which two or more electrolytes are transferred between an electrolyte solution and a complex. Ion exchange resins are insoluble polymers designed to exchange ions of solutions onto and from the surface of the resin to drive an ionic solution into the desired composition. The ion exchange resin may be manufactured as a cation resin, that attracts positively charged ions, or as an anion resin, that attracts negatively charged ions. Ion exchange resins are used in many processes for water softening, water purification, catalysis, pharmaceuticals as well as many other chemical reactions to remove harmful ions or to introduce beneficial ions into the water.

The present invention provides a method of employing an ion exchange resin charged with hydrogen ions to locally produce acids at sufficient concentrations to be used in a plurality of processes. Local production of acids reduces pollution from transportation methods, limits the possibility of hazardous spills during transportation, and requires less safety precautions for transportation vessels to transport the precursors of the acid. A cation resin exchanges the hydrogen ions with the salt cations within a salt solution. Thus, the solution becomes protonated to form an acid solution of the respective salt anion as the concentration of hydrogen increases from the addition of hydrogen atoms into the solution from the ion exchange resin.

### BRIEF DESCRIPTION OF THE DRAWINGS

FIG. 1 is a flow diagram for the overall process of the present invention.

FIG. 2 is a flow diagram for a specific embodiment of the present invention.

FIG. 3 is an ingredient list for the quantity of salt solution.

FIG. 4 is an ingredient list for the ion exchange medium.

### DETAIL DESCRIPTIONS OF THE INVENTION

### Preferred Description:

All illustrations of the drawings are for the purpose of describing selected versions of the present invention and are not intended to limit the scope of the present invention.

The present invention is a method of acid manufacturing using ion exchange resin. The present invention allows for the production of acids on location where the acid is being utilized to prevent the necessity of transporting the acid. As the present invention is executed locally to the process which the acid is needed, the present invention reduces pollution from transporting the acids, limits the possibility of hazardous spills during transportation, and requires less safety precautions for transportation vessels, such as material selection, to transport the precursors of the acid. While the present invention may be used to manufacture a plurality of acids, the present invention is preferred to be implemented in the production of hydrochloric acid or nitric acid.

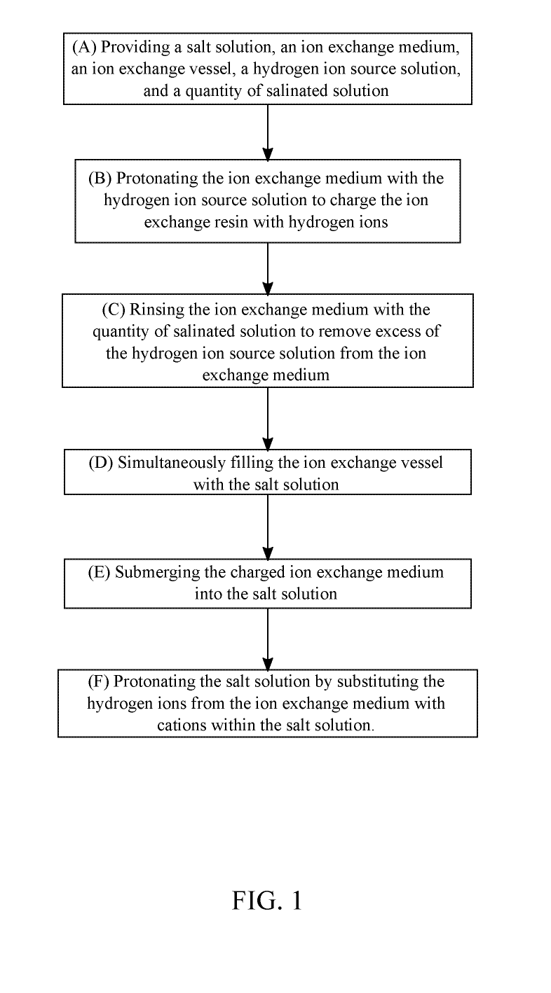

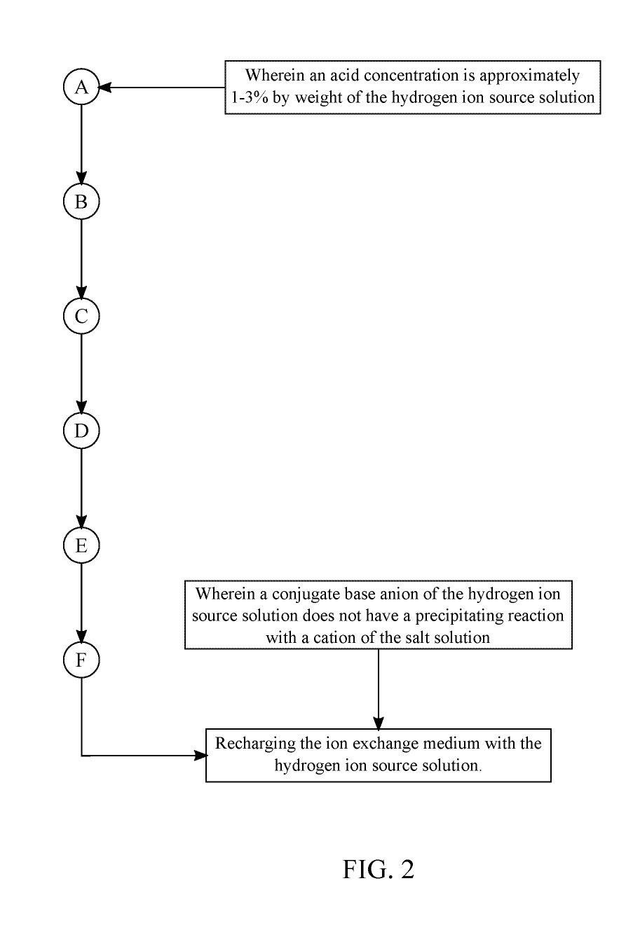

In accordance to FIG. 1, the method of acid manufacturing using ion exchange requires a plurality of starting materials and equipment that includes: a salt solution; an ion exchange medium, and an ion exchange vessel, a hydrogen ion source solution, and a quantity of salinated solution (Step A). The salt solution is a solution for a salt that has the conjugate base for the desired acid product. The ion exchange medium is a cation resin that exchanges the hydrogen ions with the salt cations within a salt solution. The ion exchange vessel is a vessel where the ion exchange occurs between the salt solution and the ion exchange medium. The hydrogen ion source is the solution or compounds that allows the ion exchange medium to be initially charged with hydrogen ions or recharged with hydrogen ions for subsequent uses. An acid concentration of the hydrogen ion source solution is approximately 1-3% by hydrogen ion source solution in order to provide a sufficient amount of hydrogen ions to protonate the ion exchange medium, shown in FIG. 2. The quantity of salinated solution is used to rinse the ion exchange medium in order to remove excess of the hydrogen ion source from the surface to increase the safety of transporting the ion exchange medium.

Initially, the ion exchange medium is protonated with the hydrogen ion source to charge the ion exchange resin with hydrogen ions (Step B). Charging the ion exchange medium with hydrogen ions saturates the ion exchange medium with hydrogen ions to be exchanged with a cation of the salt solution. The ion exchange medium is then rinsed with the quantity of salinated solution to remove excess of the hydrogen ion source solution from the ion exchange medium (Step C). Simultaneously, the ion exchange vessel is filled with the salt solution (Step D). The charged ion exchange medium is then submerged into the salt solution (Step E). When the charged ion exchange medium is submerged into the salt solution, the salt solution is protonated by substituting the hydrogen ions from the ion exchange medium with cations within the salt solution (Step F). Therefore, the concentration of hydrogen ions increases making the solution more acidic, decreasing the pH of the solution. The cation of the salt solution is absorbed by the ion exchange medium as the hydrogen ions are dispersed into the salt solution. The cations of the salt solution are then able to be removed from the resultant acid by removing the ion exchange medium.

In accordance to FIG. 2, the ion exchange medium is regenerated through a hydrogen ion source solution bath to allow the ion exchange medium to be used for repeated processes. The ion exchange medium is recharged with the hydrogen ion source solution to replace the salt cations with hydrogen ions. Therefore, allowing the production of subsequent acids through the present invention, by repeating Step B to Step F.

In accordance to the preferred embodiment of the present invention, the hydrogen ion source solution is a sulfuric acid solution, detailed in FIG. 2. As sulfuric acid is diprotic acid, each molecule of sulfuric acid includes two hydrogen atoms. Therefore, the sulfuric acid allows the sulfuric acid solution to protonate the ion exchange medium up to twice per molecule of sulfuric acid. While sulfuric acid is preferred, the hydrogen ion source solution may be any appropriate acidic solution that is able to protonate the ion exchange medium.

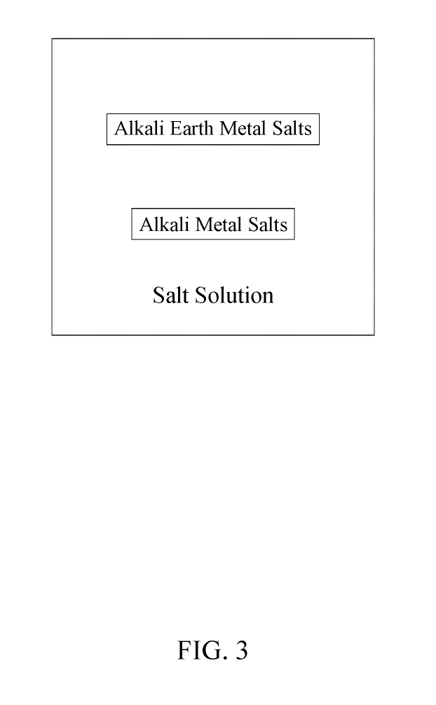

The salt solution is preferred to be selected from a group consisting of alkali metal salts, alkali earth metal salts, and combinations thereof, as shown in FIG. 3. The alkali metal salts and alkali earth metal salts are preferred as these salts readily disassociate into cations and anions when dissolved into a solvent. More specifically, the salt solution can be any ionic aqueous solution that comprises at least one cation, including but not limited to sodium, potassium, calcium, and magnesium, and at least one anion, including but not limited to nitrates, chlorides, and sulfates. The conjugate base anion of the hydrogen ion source is not preferred to form a precipitating reaction with the cation of the salt solution. If the conjugate base anion and the cation do form a precipitate, a precipitate layer would form on the ion exchange medium, thus fouling the ion exchange medium and limiting adsorption sites on the ion exchange medium. Therefore, the precipitate layer prevents binding the hydrogen ions to the ion exchange medium.

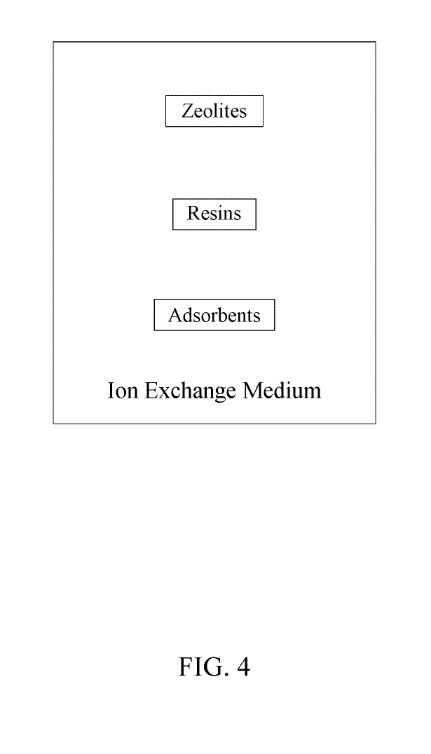

Detailed in FIG. 4, the ion exchange medium is selected from a group consisting of zeolites, resins, adsorbents, and combinations thereof. Zeolites, resins, and adsorbents are compounds that can be charged to bind with either cations or anions; preferably cations for the present invention. These compounds are selected to be inert in the substitution of ions between the ion exchange medium and salt solution. Additionally, these compounds are selected to prevent degradation of the ion exchange medium in the presence of acids and are safe to transport when charged with hydrogen ions.

### Example 1

The present invention may be employed in electric power generation applications. Utilities and other large operations that commonly use cooling towers implement lime-soda softening in the process. Production of lime produces huge amounts of carbon dioxide and when used in water softening produces a huge amount of waste solids for disposal. Moreover, lime-soda softening increases the calcium hardness in the water that eventually concentrates and forms precipitates, which will foul the cooling towers or similar apparatus. The calcium hardness of the water is reduced in the water by decreasing the pH of the water through protonation by the ion exchange medium. The total dissolved solids in the solution are then able to be primarily sodium salts and potassium salts, which are highly soluble in the water of the cooling water, present in higher concentrations. Further, the regeneration solutions from removal of salts can be concentrated to hydrates for use in storage of thermal energy.

A hydrogen cation is exchanged for the cations present in the salt solution to create an acid of the conjugate base of the salt solution. The present invention uses an acid cation resin as the ion exchange medium for contacting the salt solution to make another acid for regeneration of acid cation resin. Typically, at least 2% solution of hydrochloric acid, and preferably at least 3% for hydrochloric acid, is used in regeneration of the acid cation resin. In addition, the higher the acid concentration allows for the acid cation resin to be recharged repeatedly from the same hydrogen ion source solution.

### Example 2

A 3% of hydrochloric acid solution is generated with the ion exchange medium and sodium chloride solution. The overall weight of the solution is reduced by 41% as the sodium chloride at molecular weight of 58.453 grams/mole s exchanged to a molecular weight of approximately 24 grams/mole for hydrochloric acid as the sodium ions are removed with the ion exchange medium.

### Example 3

In particular, calcium and magnesium chlorides or nitrates are particularly valuable for use with agricultural soils and for use in storage of solar energy and other sources of heat energy. Using the present invention, an acid cation resin as the ion exchange medium is used to remove the calcium. The acid cation resin is then regenerated using an acid that does not form precipitates with any multivalent calcium or any other multivalent cation that may be present in the water. The recharging of resins to acid is a safe centralized operation. Recharged resin is used in a portable ion exchange unit that may be transported to the location that the acid will be implemented.

### Example 4

The present invention is used in pH control to prevent calcium and magnesium from precipitating with carbon dioxide and/or sulfate ions which deposit to form scale and restrict flow in pumps and pipelines. Rather than injection of hydrochloride solution, a portion of the fluid is withdrawn and contacted with the ion exchange medium, in amount to substitute a portion of the calcium and magnesium ions with hydrogen to reduce the pH value of the solution enough to avoid precipitates, as well as produce a usable brine.

### Example 5

The present invention has increased ecological benefits. Sulfuric acid that is made using sulfur dioxide, the world's largest volume acid gas, is used to recycle sodium, the world's largest volume of inorganic water pollutant, to make sodium sulfate, the world's most versatile material for storage of solar energy at child safe and pet safe temperatures between the interval of 80 degrees Fahrenheit and about 89 degrees Fahrenheit. In addition, the present invention has increased the handling safety of the acid. By adding acid to a solution through this method, a common practice for pH control, the production of scale on in heat transfer equipment, storage vessels, pumps or pipelines is minimized or prevented.

Although the invention has been explained in relation to its preferred embodiment, it is to be understood that many other possible modifications and variations can be made without departing from the spirit and scope of the invention as hereinafter claimed.

### Alternate Description:

The present invention is a method of acid manufacturing through the use of ion exchange resins. The method of acid manufacturing with ion exchange resins requires a number of different starting materials and equipment, which include a salt solution, an ion exchange medium in hydrogen form, an acid solution, and an ion exchanger. More specifically, the salt solution, also known as brine or brackish water, can be any ionic aqueous solution that comprises various cations, including but not limited to sodium, potassium, calcium, and magnesium, and various anions including but not limited to nitrates, chlorides, and sulfates. The ion exchange medium in hydrogen form may be a strong or weak cation resin, which is initially charged or saturated with hydrogen ions, allows for the removal of cation from the solution. The sulfuric acid solution is used, as an example for the purpose of description, to regenerate the ion exchange resin to allow a reuse of the ion exchange resin, as well as increase its service life. The ion exchanger is a reactor which contains the ion exchange process without oxidation or reduction between the ions present in the solution.

Moreover, the present invention has applications in deionization including production of ultrapure water, and for very frequent use in the energy production like continued use with reduction of salts in water for cooling towers that typically allows up 90% use of water, to produce natural gas and oil. When using the present invention, sulfuric acid produced from the sulfur from fuel production, especially in sulfuric acid made from sulfur dioxide from oxidation of minerals and/or combustion of coal. The latter is planned for use in construction of a government subsidized power plant dubbed as “clean burning coal”.

In addition, the present invention may also be applied in the practice of oil production, specifically through the hydraulic fracturing processes where typically hydrochloric acid is used to degrade the structure of shale formations, allowing access to previously untapped oil sources. Acidic solutions of salts which are often produced water are pumped into the natural pores and manufactured fractures opening channels for the petroleum to flow through. Oils are then extracted according to industry standards including for flooding with various liquids that assist the release and flow of oil, gases, and water solutions through the production wells. The waste stream is then treated through the present invention as ion exchange medium added to recycle the waste stream produces an effective and useable acid stream for the oil production process and, for recycling salts so the wastewater is conditioned for use in growing biomass for sustainability of fiber and fuel.

In one embodiment of the present invention, sulfuric acid is typically used for locally producing hydrochloric acid and/or nitric acid, although most acids can be made using appropriate salts. Local production of acids reduces pollution from fuel used during transport of dangerous material from distant sources. Acid local production can utilize salt solutions including, but not limited to, sodium, potassium, or other cation salts that do not precipitate in unacceptable amounts when contacted with the regeneration acid solution used for regeneration. Therefore, a plurality of acids may be manufactured using whatever salt solution is locally available. The present invention can provide an increased local use of sulfuric acid made from local acid gas and/or sulfur removed from fuels.

The present invention reduces hazards and costs for handling and transporting acid from more distant sources. Additionally, handling acid cation exchange medium charged with hydrogen ions is inherently safe as compared with handling acids themselves.

The present invention contains the steps as follows: regenerating an acid cation ion exchange medium to charge the ion exchange medium with hydrogen ions; washing the ion exchange medium using water with salinity solution; preparing a selected solution of salts for the acid to be produced, strong or weak, contacting the selected solution containing cations in concentration so low that they do form precipitates in unacceptable quantity with the anions from the selected acid; subsequently carrying out a second ion exchange reaction to substitute hydrogen for cations in the selected brine with the ion exchange medium; and converting the salt solution to an acid solution, such as hydrochloric acid or nitrate acid, depending on intended use of solution of acid. The acid solution is typically 1% to 3% or more acid content by weight, depending on molecular weight of the specific acid and intended use of the ion exchange medium, and load a ion exchange resin with hydrogen ions. The acid used herein must not form unacceptable amounts of precipitates with the cations on ion exchange medium.

The acid cation ion exchange media may be Chabazite or other Natural Zeolites, manufactured Zeolites, or resins.

In the process described above, all of the steps may be performed in the same ion exchanger or locally, with no need of transportation. In addition, the process described above is not only able to remove sodium, the world's largest inorganic water pollutant from chloride brine to form hydrochloric acid, but also able to remove metals and other elements sequentially according preference of the ion exchange medium except for calcium and/or other elements that form sulfates that precipitate under conditions of regeneration. Moreover, the same process may also be used to generate nitric acid. In this process, sulfuric acid is firstly used to regenerate an ion exchange, and then a nitrate brine is loaded to the ion exchange to generate a nitric acid. At the same time, the present invention can also remove metals and other elements sequentially according a preference of the resin because elements soluble in water do not form insoluble nitrates.

The present invention allows local production of a plurality of acids using widely distributed sulfuric acid and reduces the known hazards of handling and transport of other acids from more distant sources. When an ion exchange medium is regenerated with hydrogen ions and has been well washed to remove all traces of the four elements previously removed, that ion exchange medium is in a standard condition essentially irrespective of the anion in the acid used for regeneration. The present invention has provided a safer and economical method for regenerating ion exchange medium for a plurality of uses, including where a reduction in pH value is beneficial for limiting scale formation and/or removal of scale.

Moreover, the present invention may be employed in electric power generation processes. Utilities and other large operations using cooling towers commonly use lime-soda softening. Production of lime produces huge amounts of carbon dioxide and when used in water softening produces a huge amount of waste solids for disposal. Moreover, lime-soda softening leaves a troublesome amount of calcium hardness in the “soft” water that eventually concentrates and forms precipitates, which will foul the cooling towers or similar apparatus. Use the acid ion exchange is able to reduce the fouling from high concentrations of calcium ions to a very low level as the pH of the solution is lowered. The buildup in salts is primarily sodium and potassium which are highly soluble and the cooling water can thus be used to much higher concentrations. Further, the regeneration brines from removal of salts can be concentrated to hydrates for use in storage of thermal energy.

Exchange of a hydrogen cation for any other cation creates an acid of the anion previously associated with that anion. The present invention may be implemented through various embodiments. The present invention uses an ion exchange medium charged with hydrogen ions for contacting a solution of salt strong enough to make another acid for regeneration of the ion exchange resin. Typically, at least 2% for HCl, and preferably at least 3% for hydrochloride acid when used in regeneration of ion exchange medium. In addition, the higher the acid content, the more uses in addition to regeneration of the ion exchange medium.

In one example of the present invention, about 3% of hydrogen chloride is generated with ion exchange medium and sodium chloride brine. A change from sodium chloride at molecular weight of 58.453 to molecular weight of about 24 for hydrogen chloride is a 41% reduction in produced weight from starting material to the obtained product. Sulfuric acid will produce certain CaSO4 precipitates, and some other multivalent cations will precipitate as small solids that are mixed with the ion exchange medium, and therefore sulfuric acid is not used with those salt solutions. Sulfuric acid is used to make acids primarily to remove such cations which are predominately in low amounts as compared with sodium, and because removing them separately, provides products with beneficial use or uses. In particular the calcium chlorides, magnesium chlorides, or nitrates are particularly valuable for use with agricultural soils and for use in storage of solar energy and other sources of thermal energy.

In the present invention, a hydrogen charged ion exchange medium is used to remove the calcium ions. The regeneration is performed using an acid that does not precipitates form precipitates with the calcium ions or any other multivalent cation that may present in the water. An example of safety benefits of the present invention is the regeneration of ion exchange medium with hydrogen ions in a safe centralized operation. Regenerated ion exchange medium is used in portable ion exchange vessel that may be transported to a location where the acid will be implemented.

The present invention exemplifies use in pH control of calcium and magnesium solutions to prevent forming of precipitates with carbon dioxide and/or sulfate ions which deposit to form scale and restrict flow in pumps and pipelines. Rather than injection of dangerous hydrochloride solution, a portion of the fluid is withdrawn, contacted with the ion exchange medium charged with hydrogen ions, in sufficient amount to replace a portion of calcium ion or a portion of magnesium ions with hydrogen ions to reduce the pH value of the solution enough to avoid precipitates, as well as produce a usable brine.

The present invention has increased ecological benefits. Sulfuric acid that is made using sulfur dioxide, the world's largest volume acid gas, is used to recycle sodium, the world's largest volume of inorganic water pollutant, to make sodium sulfate, the world's most versatile material for storage of solar energy at child safe and pet safe temperatures in narrowed between an interval selected between 80 degrees Fahrenheit and about 89 degrees Fahrenheit. In addition, it has increased the safety for handling the hazardous acid. Adding acid to a solution is a common practice for pH control and is much used to minimize or prevent scale in heat transfer equipment, storage vessels, pumps and pipelines.

Although the invention has been explained in relation to its preferred embodiment, it is to be understood that many other possible modifications and variations can be made without departing from the spirit and scope of recycling as previously described in U S patents.

### REFERENCES

1. U.S. Pat. No. 6,071,411, Method of treating soil for controlling dust and for effecting soil stabilization through the application of waste water, Jun. 6, 2000, Gerald J. Grott
   Note: Dust control and soil stabilization as in road beds, foundations, earthen dams, etc. Road bases in Northern Indiana and southern Michigan in 1960's have required minimal repair as compared with other road bases. Millions of tons of salts are required to optimize productivity of crop soils and increase permeability to gases and Water. Reduces Flood Water and retains it for use during summers.
2. U.S. Pat. No. 6,374,539, Methods of utilizing waste waters produced by water purification processing, Apr. 23, 2002, Gerald J. Grott
   Note: Use of sodium chloride and/or sodium sulfate to remediate excess calcium carbonate in soils. There are huge acreages of Carbonaceous soils in Arizona, California, New Mexico and on the east side of the continental divide. south of an East-West line through mid-Oklahoma, where summer soil temperatures can reach the 83 degrees Fahrenheit which is the temperature at which a Root eating Fungus will grow, but only if the carbon dioxide in the soil atmosphere reaches a minimum amount. High calcium and/or high sodium content result in soils with low permeability to gases as well as low permeability to water. Known as “Texas Root Rot,” by late 1800's the Texans funded an Agricultural Research Facility at College Station with specific goal of finding a remedy for Texas Root Rot. Eventually College Station became the base for Texas A&M Agricultural School but the cause for “Texas Root Rot” was discovered by Dr. Stuart D. Lyda while he was a Professor in Nevada. First, he found that only the roots of dicots were attacked. But that includes alfalfa, citrus, cotton and nuts which age large volume in Texas so College Station employed Dr. Lyda. Dr. Lyda found that adding one ton/acre of lowest grade of mined sodium chloride would cure Texas Root Rot. (about 95% sodium chloride or 1900 pounds per acre). Research and development in Montana found optimum treatment for all crops is about the same. We sold many truckloads of salt to Cotton Farmers who leased or purchased idle calcareous land, added a measured amount of salt and grew bumper crops. Cotton Incorporated gave massive support but environmentalists soon objected to adding chloride which would eventually reach the water table and Cotton Inc. quit advertising their support. But the sodium does the work and we patented use of both recycled sodium chloride and sodium sulfate.
3. U.S. Pat. No. 6,651,383, Methods of utilizing waste waters produced by water purification processing, Nov. 25, 2003, Gerald J. Grott
4. U.S. Pat. No. 7,353,634, Methods of utilizing waste waters produced by water purification processing, Apr. 8, 2008, Gerald J. Grott
5. U.S. Pat. No. 7,622,044, Methods of sealing ponds and increasing water catchment with purified waste water, Nov. 24, 2009, Gerald J. Grott
6. U.S. Pat. No. 7,771,600, Methods of utilizing waste waters produced by water purification processing, Aug. 8, 2010, Gerald J. Grott
7. U.S. Pat. No. 7,717,173, Methods of improving oil or gas production with recycled, increased sodium water, May 18, 2010, Gerald J. Grott
   Note: Includes use of electrolysis because caustic soda and bleach were used in the successful department of energy chemically enhanced oil recovery tests where we supplied the sodium chloride very low in calcium and magnesium used in improving oil recovery. Also covers some practices for recycling fracking water.
8. U.S. Pat. No. 7,823,641, Methods of formulating cements for drilled wells using processed waste water, Nov. 2, 2010, Gerald J. Grott
   Note: For sealing well casings.
9. U.S. Pat. No. 7,866,916, Methods for deicing roads, Jan. 11, 2011, Gerald J. Grott
   Note: Recycled brines and salts for Ice Control.
10. U.S. Pat. No. 7,947,185, Water sanitation methods, May 24, 2011, Gerald J. Grott
   Note: A portion of the microbial contaminated water (as in drinking water, acid gas water, or sewage water) is electrolyzed to make bleach for use with the contaminated water
11. U.S. Pat. No. 8,062,532, Process for electrolytic production of chlorine products and byproducts, Nov. 22, 2011, Gerald J. Grott
   Note: Use Recycled sodium chloride as feed for electrolysis operations.
12. U.S. Pat. No. 8,091,653, Methods of formulating weighting agents using processed waste waters, Jan. 10, 2012, Gerald J. Grott
   Note: Use of Recycled Sodium chloride and calcium chloride as weighting agents in drilling fluid and fracking water.
13. U.S. Pat. No. 8,192,633, Methods of energy storage and transfer, Jun. 5, 2012, Gerald J. Grott
   Note: Use of low grade natural or recycled sodium sulfate in energy storage.
14. U.S. Pat. No. 8,210,768, Methods for deicing roads, Jul. 3, 2012, Gerald J. Grott Note: Deicing salts to cover gaps
15. U.S. Patent Application 20110257052, Method for Practicing Microbial Enhanced Oil Recovery Using Nitrogen Containing Fertilizers Recovered from Contaminated Water for Feeding Microbes, Oct. 3, 2012, Gerald J. Grott
   Note: A method of using nitrates, nitrites, or ammonium recovered from contaminated water for feeding microbes used in microbial enhanced oil recovery (MEOR). If required, the nitrogen waste removed from contaminated waters is treated to be converted as nitrates or nitrites. The nitrates and nitrites are mixed with microbes that are then injected into oil wells for improved tertiary oil production or injected separately depending on balance of feed and microbes in well brine as judged from examining brine that exits the well with the oil. The use of nitrates recovered from contaminated waters to feed microbes in MEOR is cost effective for both the process of water decontamination and oil recovery. Our discovery that the modest amount of potassium chloride fertilizer in the produced water from oil wells in Monterey shale and Bakken shale makes recycling possible.
16. U.S. Patent Application 20120061315, Method of Recovering Potassium from Waste Waters for Use in Purification of Waste Water, including the Waste Water from which the potassium is Recycled, while retaining the Potassium in forms suitable for use as a Nutrient in Growing Microbes, Plants and Algae, Mar. 15, 2012, Gerald J. Grott
   Note: There is a high probability for potash in other oil shales. This application was developed to replace high costs for destruction of nitrates in sewage water with profitable recovery and sale.
17. U.S. Patent Application 20120260707, Using Nitrogen Containing Fertilizers Recovered from Contaminated Water for Feeding Plants and Algae, Oct. 18, 2012, Gerald J. Grott
   Note: A method of using nitrates, nitrites, or ammonium recovered from contaminated water for feeding plants and algae. If required, the nitrogen waste removed from contaminated waters is treated to be converted as nitrates or nitrites to become readily absorbed by plants and algae. The use of nitrogen containing fertilizer recovered from contaminated waters to feed plants and algae is cost effective for both the process of water decontamination and the growth of plants and algae.
18. GROTT G. J., Changing Waste Irrigation Waters from Pollutant to Beneficial Products; A Study of Recovery and Use of Salts from the Salton Sea, 8th World Salt Symposium, 2000, The Hague
19. Buy Recycled, Website (http://www.calrecycle.ca.gov/BuyRecycled/), Jun. 30, 2015
   Note: State agencies must purchase recycled products instead of non-recycled. 100 percent recycled and there is no minimum-content required.
20. ENVIRONMENTAL AND ENERGY STUDY INSTITUTE, Building and Climate Change, December 2017, Environmental and Energy Study Institute
21. MARDIANA AND RIFFAT, J, Building Energy Consumption and Carbon Dioxide Emissions: Threat to Climate Change, Research Article, 2015, Earth Science and Climatic Change
22. WHEATON AND LEFEVRE, Fundemantals of Ion Exchange, Research Article, June 2000, The Dow Chemical Company
   Note: A cation exchange resin with a negatively charged matrix and exchangeable positive ions (cations) is shown in. FIG. 1. Ion exchange materials are sold as spheres or sometimes granules with a specific size and uniformity to meet the needs of a particular application.
23. Ion-exchange resin, Website: en.wikipedia.org/wiki/Ion-exchange_resin, 2017, Wikipedia
   Note: Resins are widely used in different separation, purification, and decontamination processes. The most common examples are water softening and water purification. In many cases ion-exchange resins were introduced in such processes as a more flexible alternative to the use of natural or artificial zeolites.
24. WATER PROFESSIONALS, Industrial water treatment, Website: http://www.waterprofessionals.com/learning-center/, 2017, Water Professionals
   Note: The identity of the ions that a resin releases to the water, the process may result in water purification or in control of the concentration of a particular ion in a solution. An ion exchange is the reversible exchange of ions between a liquid and a solid. This process is generally used to remove undesirable ions from the solution.
25. SUSHA CHERIYEDATH, How Does Ion Exchange Chromatography Work?, Website: https://www.news-medical.net/life-sciences/How-Does-Ion-Exchange-Chromatography-Work.aspx, Aug. 9, 2016
   Note: Ion exchange (IEX) chromatography is a technique that is commonly used in biomolecule purification. It involves the separation of molecules on the basis of their charge.

This technique exploits the interaction between charged molecules in a sample and oppositely charged moieties in the stationery phase of the chromatography matrix. This type of separation is difficult using other techniques as charge is easily manipulated by the pH of buffer used.

Two types of ion exchange separation is possible—cation exchange and anion exchange. In anion exchange the stationary phase is positively charged whilst in cation exchange it is negatively charged.

Principle of Ion Exchange Chromatography IEX chromatography is used in the separation of charged biomolecules. The crude sample containing charged molecules is used as the liquid phase. When it passes through the chromatographic column, molecules bind to oppositely charged sites in the stationary phase.

The molecules separated on the basis of their charge are eluted using a solution of varying ionic strength. By passing such a solution through the column, highly selective separation of molecules according to their different charges takes place.

What is claimed is:

1. A method of acid manufacturing using ion exchange resins comprises the steps of:
(A) providing a salt solution, an ion exchange medium, an ion exchange vessel, a hydrogen ion source solution, and a quantity of salinated solution;
(B) protonating the ion exchange medium with the hydrogen ion source solution to charge the ion exchange resin with hydrogen ions;
(C) rinsing the ion exchange medium with the quantity of salinated solution to remove excess of the hydrogen ion source solution from the ion exchange medium;
(D) simultaneously filling the ion exchange vessel with the salt solution;
(E) submerging the charged ion exchange medium into the salt solution; and
(F) protonating the salt solution by substituting the hydrogen ions from the ion exchange medium with cations within the salt solution.

2. The method of acid manufacturing using ion exchange resins, as claimed in claim 1, comprises the step of:
recharging the ion exchange medium with the hydrogen ion source solution.

3. The method of acid manufacturing using ion exchange resins, as claimed in claim 2, wherein a conjugate base anion of the hydrogen ion source solution does not have a precipitating reaction with a cation of the salt solution.

4. The method of acid manufacturing using ion exchange resins, as claimed in claim 1, wherein an acid concentration is approximately 1-3% by weight of the hydrogen ion source solution.

5. The method of acid manufacturing using ion exchange resins, as claimed in claim 1, wherein the salt solution is selected from the group consisting of alkali metal salts, alkali earth metal salts and combinations thereof.

6. The method of acid manufacturing using ion exchange resins, as claimed in claim 1, wherein the ion exchange medium is selected from the group consisting of zeolites, resins, adsorbents, and combinations thereof.
